(19) United States
(12) Patent Application Publication
(10) Pub. No.: US 2014/0316607 A1
(43) Pub. Date: Oct. 23, 2014

(54) OCCUPANT PRESENCE DETECTION AND IDENTIFICATION

(71) Applicant: FORD GLOBAL TECHNOLOGIES, LLC, Dearborn, MI (US)

(72) Inventors: Jialiang Le, Canton, MI (US); Manoharprasad K. Rao, Novi, MI (US); Kwaku O. Prakah-Asante, Commerce Township, MI (US)

(73) Assignee: FORD GLOBAL TECHNOLOGEIS, LLC, Dearborn, MI (US)

(21) Appl. No.: 13/865,490

(22) Filed: Apr. 18, 2013

(51) Int. Cl. B60R 16/037

(52) U.S. Cl. CPC B60R 16/037
USPC 701/1

(57) ABSTRACT

A system includes a presence sensor that generates a presence signal representing a presence of an occupant in a vehicle, an occupant identification device that generates an occupant identification signal, and a customization controller that applies a default setting to a vehicle feature before receiving the occupant identification signal and applies a customized setting associated with an identified occupant after receiving the occupant identification signal. A method includes receiving a presence signal representing a presence of an occupant in a vehicle, applying a default setting to a vehicle feature in response to receiving the presence signal, receiving an occupant identification signal after customizing the vehicle feature according to the default setting, and applying a customized setting to the vehicle feature. The customized setting is associated with the identified occupant.

### BACKGROUND

Passenger vehicles include various features that assist and provide conveniences to occupants. For example, some vehicles allow occupants to adjust various characteristics of the occupant's seat in the vehicle. Vehicle seats can be moved, reclined, tilted, etc. Moreover, some vehicle seats provide occupants with adjustable lumbar support. Some vehicles seats automatically adopt various configurations (e.g., height, tilt, recline, etc.) based on previous configurations set by the driver or another vehicle occupant. Vehicles with such features sometimes identify the occupant based on the key used to start the vehicle ignition. When the key is inserted into the ignition system, the vehicle automatically moves the seat according to the preferences of the occupant associated with the key.

### SUMMARY

An exemplary system includes a presence sensor that generates a presence signal representing a presence of an occupant in a vehicle, an occupant identification device that generates an occupant identification signal, and a customization controller that applies a default setting to a vehicle feature before receiving the occupant identification signal and applies a customized setting associated with an identified occupant after receiving the occupant identification signal. The system may be included in a vehicle.

An exemplary method includes receiving a presence signal representing a presence of an occupant in a vehicle, applying a default setting to a vehicle feature in response to receiving the presence signal, receiving an occupant identification signal after customizing the vehicle feature according to the default setting, and applying a customized setting to the vehicle feature. The customized setting is associated with the identified occupant.

### BRIEF DESCRIPTION OF THE DRAWINGS

FIG. 1 illustrates an exemplary vehicle that can apply a default setting to a vehicle feature before identifying an occupant and a customized setting to the vehicle feature after identifying the occupant.

FIG. 2 illustrates an exemplary seat having an embedded presence sensor that may be used in the vehicle of FIG. 1.

FIG. 3 is a block diagram of exemplary components that may be used in the vehicle of FIG. 1.

FIG. 4 is a flowchart of an exemplary process that may be implemented by one or more of the vehicle components of FIG. 3.

### DETAILED DESCRIPTION

An exemplary system includes a presence sensor that generates a presence signal representing a presence of an occupant in a vehicle, an occupant identification device that generates an occupant identification signal, and a customization controller that applies a default setting to a vehicle feature before receiving the occupant identification signal and applies a customized setting associated with an identified occupant after receiving the occupant identification signal. By applying the default setting before identifying the occupant, some vehicle features are made available to the occupant before the vehicle is started. Further, once the occupant is identified, the settings are updated according to the customized settings of the identified occupant.

FIG. 1 illustrates an exemplary vehicle 100 that can detect and verify the identity of an occupant. The vehicle 100 may take many different forms and include multiple and/or alternate components and facilities. While an exemplary vehicle 100 is shown, the exemplary components illustrated in the Figures are not intended to be limiting. Indeed, additional or alternative components and/or implementations may be used.

As illustrated in FIG. 1, the vehicle 100 includes doors 105 that allow an occupant to enter into a passenger compartment 110 of the vehicle 100. The passenger compartment 110 may include one or more seats 115 and controls that permit the occupant to operate the vehicle 100. Example controls (some of which are not shown) may include a steering wheel 120, brake and accelerator pedals, an instrument panel, a gear shifter, turn signals, climate controls, entertainment system controls, etc. The occupant may open the doors 105 by actuating a door handle 125.

In general, the vehicle 100 may be operated from the passenger compartment 110. After the occupant enters the vehicle 100, the occupant may insert and turn a key to start an ignition system. The period of time before the key is inserted into the ignition system may be referred to as “prior to ignition” and the period of time after the key is inserted may be referred to as “after ignition.” Moreover, certain vehicles 100 may include “keyless” ignition, in which case “prior to ignition” may refer to the period of time before the vehicle 100 is started (by, e.g., pressing a start button) and “after ignition” may refer to the period of time after the vehicle is started (e.g., after the start button is pressed). After ignition, the occupant may drive or otherwise operate the vehicle 100. Although illustrated as a passenger vehicle, and in particular a car, the vehicle 100 may alternatively be any other form of transportation. For instance, the vehicle 100 may be a sport utility vehicle 100, passenger or commercial truck, a train, an airplane, a boat, etc.

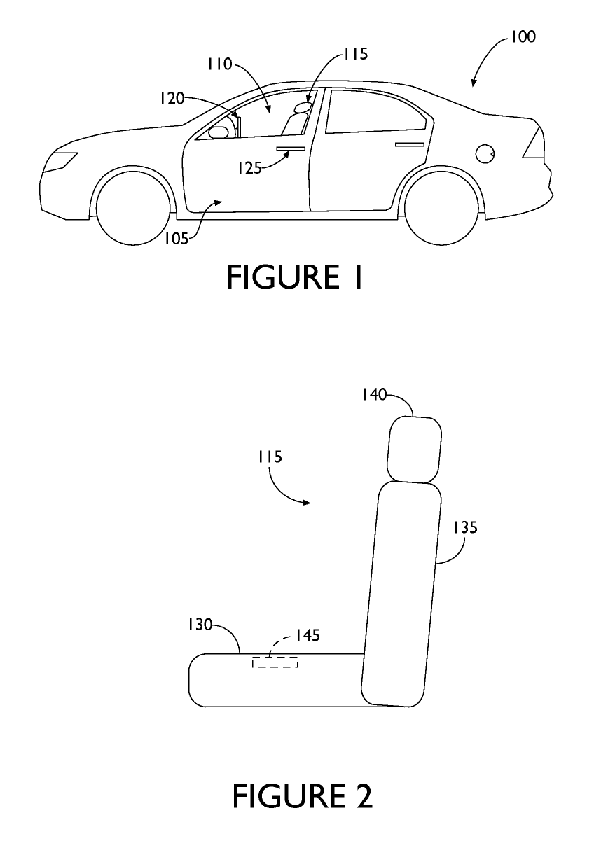

Referring now to FIG. 2, one or more seats 115 may be located inside the passenger compartment 110 of the vehicle 100. Only one seat 115 is shown in FIG. 2 for purposes of simplicity. The seat 115 may include a base 130, a backrest 135, and a headrest 140. These components may be configured to move relative to the vehicle 100 or relative to one another.

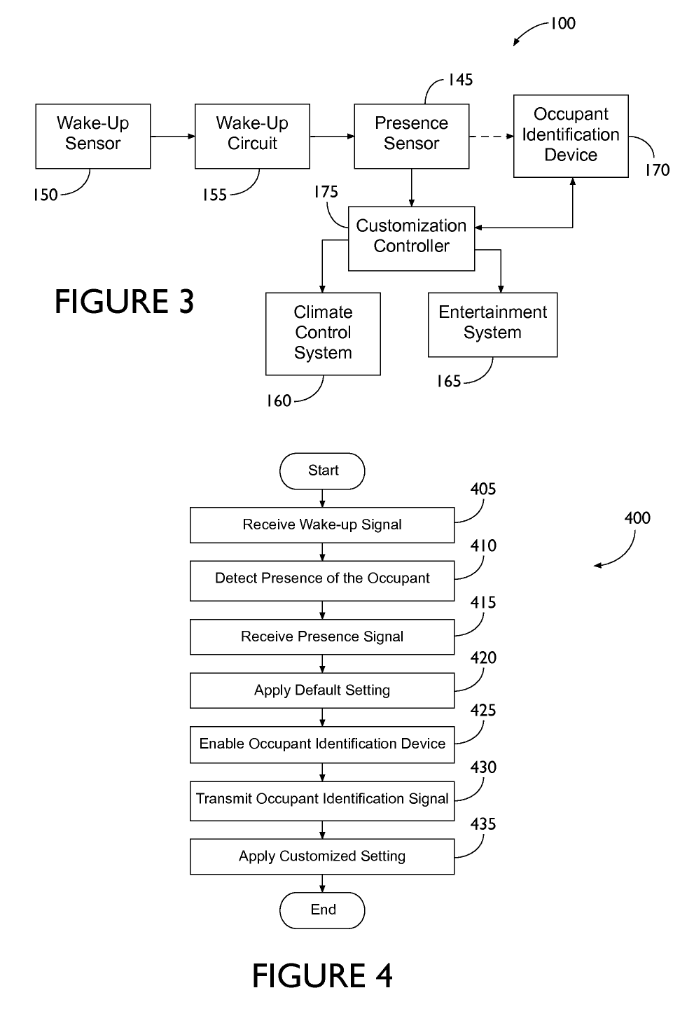

In one possible implementation, a presence sensor 145 may be embedded in the seat 115. As shown in FIG. 2, the presence sensor 145 is embedded in the base 130 of the seat 115. The presence sensor 145 may alternatively be embedded in the backrest 135, or the seat 115 may include multiple presence sensors 145 embedded in different parts of the seat 115. The presence sensor 145 may include any device configured to detect the presence of an occupant (e.g., detect when an occupant is sitting in the seat 115) and output a presence signal representing the presence of the occupant. Moreover, the presence sensor 145 may be configured to output a presence signal to one or more vehicle components to, e.g., enable those components when the occupant enters the vehicle 100 but before the ignition is started. The presence sensor 145 is discussed in greater detail below with respect to FIG. 3.

Referring now to FIG. 3, the vehicle 100 may include a wake-up sensor 150, a wake-up circuit 155, a climate control system 160, an entertainment system 165, the presence sensor 145, an occupant identification device 170, and a customization controller 175.

The wake-up sensor 150 may include any sensing device configured to detect a presence of the occupant at or near the vehicle 100. In one possible approach, the wake-up sensor 150 may include a door state sensor integrated into the door 105 of the vehicle 100 and configured to detect the occupant when the door 105 is opened. That is, when the door 105 is opened, the wake-up sensor 150 may be configured to output a door state signal representing an open state. When the door 105 is closed, the wake-up sensor 150 may be configured to output a door state signal representing the closed state. The wake-up sensor 150 may be configured to identify the presence of the occupant at or near the vehicle 100 from other indications such as a location of a key fob relative to the vehicle 100 (e.g., within a predetermined distance of the vehicle 100), when the doors 105 are unlocked either remotely or with a key, when the trunk is opened, when an occupant touches a door handle 125, or the like. Accordingly, the wake-up sensor 150 may be configured to detect the occupant before the occupant enters the vehicle 100.

The wake-up circuit 155 may include any processing device configured to enable one or more components of the vehicle 100. The wake-up circuit 155 may be configured to receive the door state signal or other signals from the wake-up sensor 150. Based on the signals received from the wake-up sensor 150, the wake-up circuit 155 may be configured to determine whether to “wake up” one or more, if any, components of the vehicle 100. If so, the wake-up circuit 155 may be configured to output one or more wake-up signals to each component to be enabled in response to the output of the wake-up sensor 150. Various vehicle components, such as the presence detector, may be configured to receive the wake-up signal. Because the wake-up signal may be generated from the output of the wake-up sensor 150, the wake-up signal may be generated and transmitted to any number of vehicle components before the occupant enters the vehicle 100. In some instances, other vehicle components such as the climate control system 160 and entertainment system 165 may also be configured to “wake up” in response to receiving the wake-up signal.

The wake-up signal may provide power to the component being awoken. Alternatively, the wake-up signal may represent a command to a particular vehicle component to begin operating. For instance, one or more vehicle components may operate in a “sleep” or other low power mode when, e.g., the vehicle 100 is off. During the “sleep mode,” the operation of the component may be limited to checking whether the wake-up signal was received from the wake-up circuit 155. If so, the component may begin operating under normal conditions, discussed below. The component may continue to operate in the “sleep” mode until the wake-up signal is received or the vehicle 100 is started.

The climate control system 160 may be configured to control a temperature of the passenger compartment 110. The climate control system 160 may include any number of blowers that push heated or cooled air into the passenger compartment 110. The climate control system 160 may, in one possible approach, be configured to turn on or awaken from a “sleep” mode in response to the wake-up signal generated by the wake-up circuit 155 or an enable signal such as the presence signal generated by the presence sensor 145. In any event, the climate control system 160 may become enabled before ignition, and in some instances, before the occupant enters the vehicle 100, giving the climate control system 160 time to initialize prior to ignition. This way, the climate control system 160 may be ready to provide the occupant with climate control options when or shortly after the occupant enters the vehicle 100. The climate control system 160 may also be configured to begin heating or cooling the passenger compartment 110 even before the occupant enters the vehicle 100. Example settings of the climate control system 160 may include a temperature of the passenger compartment 110, the speed of the fans located in the passenger compartment 110, the distribution of airflow, etc. The climate control system 160 may also be configured to automatically turn off after a prescribed amount of time if, e.g., the vehicle ignition is not turned on within the prescribed amount of time. The climate control system 160 may also be temporarily turned off while the vehicle ignition is being turned on.

The entertainment system 165 may be configured to provide media content to one or more occupants. In one possible approach, the entertainment system 165 may include a radio, music player, video player, navigation system, or the like. The entertainment system 165 may incorporate a human machine interface, such as a touchscreen configured to present media content and options to the occupant and receive selections from the occupant. The entertainment system 165 may be configured to initialize in response to a wake-up signal generated by the wake-up circuit 155 or an enable signal such as the presence signal generated by the presence sensor 145. The entertainment system 165 may therefore be ready to provide media content to the occupant as soon as or shortly after the occupant enters the vehicle 100 but before ignition. Examples of settings associated with the entertainment system 165 may include a selection of a media type (e.g., radio station, portable music player, etc.), volume, navigation system settings, connection to mobile devices via, e.g., Bluetooth®, display preferences, or the like. The entertainment system 165 may also be configured to automatically turn off after a prescribed period of time if, e.g., the vehicle ignition is not turned on within the prescribed amount of time.

The presence sensor 145 may be configured to detect the presence of the occupant and output a presence signal when the occupant is detected. As discussed above with respect to FIG. 2, the presence sensor 145 may be embedded in the seat 115. Therefore, the presence sensor 145 may be configured to output the presence signal when the occupant sits in the seat 115. The presence signal, therefore, may represent the presence of the occupant in the seat 115. In one possible implementation, the presence sensor 145 may include an electro-resistive sensor configured to deform when the occupant sits on the seat 115. The presence sensor 145 may be configured to output the presence signal according to the amount that the electro-resistive sensor has deformed to, e.g., provide information about the occupant. Characteristics of the presence signal, such as the voltage of the presence signal, may be proportional to the deformation of the electro-resistive sensor. A relatively high voltage may represent a greater amount of deformation, suggesting the presence of a larger occupant. A relatively low voltage may represent less deformation, suggesting the presence of a smaller occupant. Some other types of information that may be determined from the presence signal may include the occupant's size, weight, whether the occupant is an adult or child, whether the occupant is actually an inanimate object (e.g., a purse, briefcase, book, etc.), whether the occupant is a pet, etc. The presence sensor 145 may be configured to operate at a relatively low power and may be enabled by the wake-up circuit 155, i.e., upon receipt of the wake-up signal. The presence sensor 145 may turn off when the vehicle 100 is turned off (e.g., the key is turned to the off position or removed from the ignition) and turn on in response to the wake-up signal received from the wake-up circuit 155. Therefore, the presence sensor 145 may be enabled prior to ignition.

The occupant identification device 170 may be configured to generate an occupant identification signal that, e.g., identifies one or more occupants in the vehicle 100. In one possible approach, the occupant identification device 170 may include a camera (not shown) mounted in the passenger compartment 110, such as on the steering column, on the steering wheel 120, or on an instrument panel (not shown). The occupant identification device 170 may be mounted on a non-rotating part of the steering wheel 120, or alternatively, may rotate with the steering wheel 120 and perform image processing based on the angle of rotation. In operation, the occupant detection device may use the camera to capture one or more images of the occupant. By performing a facial recognition technique, the occupant detection device may detect recognizable features, such as facial biometric features, of the occupant, compare the facial biometric features to corresponding features of known occupants, and determine whether the current occupant is a known occupant. The occupant detection device may generate the occupant identification signal to identify the current occupant, including identifying whether the occupant is known or unknown. Information about the facial biometric features of a number of known occupants may be entered and maintained in the vehicle-based database for comparison with current occupant facial biometric features. Known occupant facial biometric database information can be entered into the vehicle-based database using wired or wireless data transfer techniques. In one possible approach, the occupant identification device 170 may be configured to operate in a “sleep” or other low power mode while the vehicle 100 is off. The occupant identification device 170 may be configured to receive the presence signal, which may cause the occupant identification device 170 to “wake up” before the vehicle 100 is started (e.g., before ignition). The occupant identification device 170 may be configured to generate and output the occupant identification signal after receiving the presence signal.

The customization controller 175 may include any computer-processing device configured to control the operation of one or more vehicle features, such as the climate control system 160 and the entertainment system 165, position of the vehicle seat 115 and mirrors, etc., prior to ignition. In some circumstances, the customization controller 175 may be configured to control at least some aspects of one or more vehicle features after ignition or for some amount of time after ignition. Moreover, only the climate control system 160 and entertainment system 165 are discussed for purposes of simplicity. The customization controller 175 may be configured to control more features than the climate control system 160 and entertainment system 165. For example, other features may include the position of the vehicle seat 115, the position of one or more mirrors, which may be located in the passenger compartment 110 or external to the vehicle 100, the position of the steering column, the position of the accelerator and/or brake pedal, or the like.

The customization controller 175 may be configured to apply various settings, including default settings or customized settings, to various vehicle features based on, e.g., the presence of the occupant, the identity of the occupant, or both. In one possible implementation, the customization controller 175 may be configured to apply a default setting when the occupant enters the vehicle 100. The customization controller 175 may, in response to receiving the presence signal, apply the default setting until the occupant can be identified by, e.g., the occupant identification device 170. Once identified, that is, once the customization controller 175 receives the occupant identification signal, the customization controller 175 may apply a customized setting associated with the identified occupant. The customization controller 175 may be configured to access the customized setting from a memory device (not shown) storing a database linking customized settings to known occupants. In one possible approach, the default setting may be the customized setting of one of the occupants, such as the occupant most often present in the vehicle 100, the occupant with a particular key, the occupant registered with the vehicle 100 as the “primary driver,” etc. Alternatively, the default setting may include the setting at the time when the ignition was most recently turned off.

The customization controller 175 may be configured to operate in a “sleep” or other low power mode while the vehicle 100 is turned off. The customization controller 175 may be configured to awaken in response to receiving the presence signal. Upon receipt of the presence signal but before receiving the occupant identification signal, the customization controller 175 may be configured to apply a first customized setting associated with a first occupant. The first occupant may have been previously identified as the occupant most often present in the vehicle 100, the occupant with a particular key, the occupant registered as the “primary driver” of the vehicle 100, or the like. Alternatively, the customization controller 175 may be configured to apply a default setting, which may include the setting at the time when the ignition was most recently turned off.

After the customization controller 175 receives the occupant identification signal, which as discussed above identifies the occupant, the customization controller 175 may change the settings applied. For instance, the occupant identification signal may identify the occupant as a second occupant associated with a second customization setting. Therefore, the customization controller 175 may apply the second customization setting to the vehicle feature instead of the first customization setting or the default setting. The customization controller 175 may access the first customization setting, the second customization setting, and the default setting from the memory device, and more particularly, from a database linking different settings to different occupants and the default setting to an “unknown” occupant.

After applying the appropriate customization setting, the customization controller 175 may be configured to relinquish control of the vehicle feature. That is, the customization controller 175 may be configured to allow the occupant to directly control, e.g., the climate control system 160, the entertainment system 165, or the like. Moreover, by relinquishing control, the customization controller 175 may allow other vehicle components to control the vehicle features.

In general, computing systems and/or devices, such as the wake-up sensor 150, the wake-up circuit 155, the presence sensor 145, the occupant identification device 170, the customization controller 175, the climate control system 160, and the entertainment system 165, may employ any of a number of computer operating systems, including, but by no means limited to, versions and/or varieties of the embedded operating systems, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance.

Computing devices generally include computer-executable instructions, where the instructions may be executable by one or more computing devices. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above. Various sensors, circuits, controllers and systems such as climate control system and entertainment system may be connected and operated by means of vehicle level networks such as CAN (Controller Area Network) and LAN (Local Area Network), etc.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

FIG. 4 is a flowchart of an exemplary process 400 that may be implemented with one or more of the vehicle components shown in FIG. 3.

At block 400, the presence sensor 145 may receive the wake-up signal generated by, e.g., the wake-up sensor 150 and transmitted from the wake-up circuit 155. As discussed above, the wake-up signal may indicate that an occupant is at or near the vehicle 100 but has not entered the vehicle 100 yet. The wake-up signal may be generated under various circumstances such as a location of a key fob relative to the vehicle 100 (e.g., within a predetermined distance of the vehicle 100), when the doors 105 are unlocked either remotely or with a key, when the trunk is opened, when an occupant touches a door handle 125, or the like. The wake-up circuit 155 may process the signals received from the wake-up sensor 150 and generate the wake-up signal if, e.g., the wake-up circuit 155 determines that the occupant is at or near the vehicle 100.

At block 410, the presence sensor 145 may detect the presence of the occupant. The presence sensor 145 may be embedded in a seat 115 inside the passenger compartment 110 of the vehicle 100. The occupant, therefore, may be detected when the occupant sits in the seat 115. The presence sensor 145 may generate and output the presence signal to indicate that the occupant is in the vehicle 100 and sitting in the seat 115.

At block 415, the customization controller 175 may receive the presence signal from, e.g., the presence sensor 145. In response to receiving the presence signal, the customization controller 175 may enable one or more vehicle features, such as the climate control system 160 and the entertainment system 165, so that the enabled vehicle features may begin operating as soon as the vehicle 100 is started. Some of the features, such as, the entertainment system 165 and the climate control system 160 may operate as soon as the occupant is seated in the vehicle 100, even before the vehicle 100 is started. Some of the systems, such as the climate control system 160 and the entertainment system 165 may automatically turn off after a prescribed period of time, such as if the vehicle ignition is not turned on during the prescribed period of time.

At block 420, the customization controller 175 may apply a default setting to the vehicle features enabled at block 415. The default setting may cause the enabled vehicle features to operate according to default settings stored in a memory device accessible to the customization controller 175. Moreover, the settings stored in the memory device may be associated with different known occupants. Therefore, the default setting may include the settings associated with one or more known occupants. Alternatively, the customization controller 175 may select the value of the most recent setting at the time when the ignition was turned off.

At block 425, the customization controller 175 may enable the occupant identification device 170. Alternatively, the occupant identification device 170 may be enabled by the presence signal received from, e.g., the presence sensor 145. In some implementations, the customization controller 175 may enable the occupant identification device 170 prior to applying the default setting. Because the occupant identification device 170 is enabled by the presence signal or by the customization controller 175, the occupant identification device 170 may determine the identity of the occupant prior to ignition.

At block 430, the occupant identification device 170 may generate and transmit the occupant identification signal to, e.g., the customization controller 175. The occupant identification signal may identify the current occupant by comparing characteristics of the current occupant to characteristics of known occupants. The occupant identification device 170 may include a camera that can detect facial biometric characteristics of the current occupant. The occupant identification device 170 may compare the detected facial biometric characteristics to the facial biometric characteristics of known occupants to determine whether the current occupant is a known occupant. The occupant identification signal may identify the current occupant as a known occupant or indicate that the current occupant is an unknown occupant.

At block 435, the customization controller 175 may identify the current occupant from the occupant identification signal received and apply a customized setting to the vehicle feature. The customized setting may be based on the identified occupant. For instance, the customization controller 175 may determine which settings stored in the memory device correspond to the identified occupant and apply those settings to the vehicle features such as the climate control system 160 and the entertainment system 165. In some instances, the customized setting may the same or different from the default setting applied at block 420.

The process 400 may end after block 435.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system comprising:
a presence sensor configured to generate a presence signal representing a presence of an occupant in a vehicle;
an occupant identification device configured to generate an occupant identification signal; and
a customization controller configured to apply a default setting to a vehicle feature before receiving the occupant identification signal and apply a customized setting associated with an identified occupant after receiving the occupant identification signal.

2. The system of claim 1, wherein the presence signal enables the occupant identification device and wherein the occupant identification device is configured to transmit the occupant identification signal to the customization controller after the presence signal is received by the customization controller.

3. The system of claim 1, wherein the default setting is different from the customized setting.

4. The system of claim 1, wherein the customization controller is configured to apply a first customized setting associated with a first occupant and apply a second customized setting associated with a second occupant, wherein the default setting is the same as the first customized setting.

5. The system of claim 1, wherein the default setting includes a setting being applied at the time the vehicle was most recently turned off.

6. The system of claim 1, wherein the presence sensor is configured to detect the presence of the occupant in the vehicle.

7. The system of claim 6, wherein the presence sensor is embedded in a vehicle seat.

8. The system of claim 1, further comprising:
a wake-up circuit configured to output a wake-up signal configured to enable the presence sensor; and
a wake-up sensor configured to determine when the occupant is near the vehicle.

9. A vehicle comprising:
a seat located in a passenger compartment;
a presence sensor embedded in the seat and configured to generate a presence signal representing a presence of an occupant when the occupant sits in the seat;
an occupant identification device located in the passenger compartment, wherein the occupant identification device is configured to generate an occupant identification signal; and
a customization controller configured to apply a default setting to a vehicle feature before receiving the occupant identification signal and apply a customized setting associated with the occupant after receiving the occupant identification signal.

10. The vehicle of claim 9, wherein the presence signal enables the occupant identification device and wherein the occupant identification device is configured to transmit the occupant identification signal to the customization controller after the presence signal is received by the customization controller.

11. The vehicle of claim 9, wherein the default setting is different from the customized setting.

12. The vehicle of claim 9, wherein the customization controller is configured to apply a first customized setting associated with a first occupant and apply a second customized setting associated with a second occupant, wherein the default setting is the same as the first customized setting.

13. The vehicle of claim 9, wherein the default setting includes a setting being applied at a time when the vehicle was most recently turned off.

14. The vehicle of claim 9, wherein the presence sensor is configured to detect the presence of the occupant in the vehicle.

15. The vehicle of claim 9, further comprising:
a wake-up circuit configured to output a wake-up signal configured to enable the presence sensor; and
a wake-up sensor configured to determine when the occupant is near the vehicle.

16. A method comprising:
receiving a presence signal representing a presence of an occupant in a vehicle;
applying a default setting to a vehicle feature in response to receiving the presence signal;
receiving an occupant identification signal after customizing the vehicle feature according to the default setting, wherein the occupant identification signal identifies the occupant; and
applying a customized setting to the vehicle feature, wherein the customized setting is associated with the identified occupant.

17. The method of claim 16, further comprising:
enabling the occupant identification device with the presence signal; and
transmitting the occupant identification signal to the customization controller after the presence signal is received.

19. The method of claim 16, wherein applying the default setting includes:
applying a first customized setting associated with a first occupant; and
applying a second customized setting associated with a second occupant, wherein the default setting is the same as the first customized setting.

20. The method of claim 16, further comprising:
receiving a wake-up signal; and
detecting the presence of the occupant in the vehicle after receiving the wake-up signal.
